(19) United States
(12) Patent Application Publication
(10) Pub. No.: US 2008/0238312 A1
(43) Pub. Date: Oct. 2, 2008

(54) Plasma display panel

(76) Inventor: Jung-Suk Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/076,902

(22) Filed: Mar. 25, 2008

(30) Foreign Application Priority Data
Mar. 28, 2007 (KR) 10-2007-0030364

(51) Int. Cl. H01J 1/62; H01J 17/49; H01J 9/395

(52) U.S. Cl. 313/512; 313/586; 445/11

(57) ABSTRACT

A plasma display panel (PDP) includes a first substrate and a second substrate facing each other, an upper dielectric layer on the first substrate, a plurality of discharge electrodes between the first and second substrates, and a plurality of barrier ribs to define a plurality of discharge cells between the first and second substrates, each of the barrier ribs having a first portion and a central portion, the first portion having a width different than a width of the central portion, and each of the barrier ribs having a complimentary color with respect to a color of the first substrate and/or a color of the upper dielectric layer.

### BACKGROUND OF THE INVENTION

1. Field of the Invention

Embodiments of the present invention relate to a plasma display panel. More particularly, embodiments of the present invention relate to a plasma display panel having a reduced cell pitch and capable of exhibiting increased brightness and decreased failure rate of barrier ribs.

2. Description of the Related Art

A plasma display panel (PDP) is a flat display panel that displays images via gas discharge phenomenon. The conventional PDP may include upper and lower panels, a plurality of barrier ribs that define a plurality of discharge cells between the upper and lower panels, a photoluminescent layer in each discharge cell, and a discharge gas. More specifically, in a conventional PDP, discharge gas may be supplied between two panels having a plurality of electrodes, so that upon application of a discharge voltage to the electrodes, the discharge gas may generate ultraviolet (UV) light to excite the photoluminescent layer in respective predetermined discharge cells to emit visible light. Each discharge cell may emit a different light, i.e., red, green, or blue, so that three adjacent discharge cells emitting three different lights may form a single pixel.

A high resolution of the conventional PDP may require an increased number of pixels therein, thereby necessitating a reduced pitch between the discharge cells.

However, a reduced pitch between the discharge cells may decrease a surface area covered by the photoluminescent layer in each discharge cell, thereby reducing overall brightness of the PDP. Accordingly, there exists a need for a PDP with a reduced pitch between discharge cells capable of exhibiting high brightness values.

### SUMMARY OF THE INVENTION

Embodiments of the present invention are therefore directed to a plasma display panel (PDP), which substantially overcomes one or more of the disadvantages of the related art.

It is therefore a feature of an embodiment of the present invention to provide a PDP having a structure capable of increasing brightness.

It is another feature of an embodiment of the present invention to provide a PDP having a reduced discharge cell pitch and a decreased failure rate of barrier ribs.

It is yet another feature of an embodiment of the present invention to provide a PDP exhibiting a reduced reflection of external light.

At least one of the above and other features and advantages of the present invention may be realized by providing a PDP including a first substrate and a second substrate facing each other, an upper dielectric layer on the first substrate, a plurality of discharge electrodes between the first and second substrates, and a plurality of barrier ribs to define a plurality of discharge cells between the first and second substrates, each barrier rib having a first portion and a central portion, the first portion having a width different than a width of the central portion, and each barrier rib having a complimentary color with respect to a color of the first substrate and/or a color of the upper dielectric layer. The PDP may further include a photoluminescent layer in each discharge cell.

The central portion of each barrier rib may be between the first portion and a second portion, the first portion being wider than the central portion along a first direction. The first portion of each barrier rib may be wider than the central portion of the barrier rib along a second direction. The second portion of each barrier may be wider than the central portion.

The upper dielectric layer and/or the first substrate may overlap with portions of the barrier ribs to define opaque regions. The upper dielectric layer and/or the first substrate may be substantially blue, and the barrier ribs may be substantially brown. The cell pitch of the discharge cells may be about 750 μm or less.

At least a first set of the barrier ribs may extend parallel to the discharge electrodes and include a double structure. Each of the barrier ribs of the first set may include a first barrier rib portion, a second barrier rib portion, and a non-discharge space therebetween. The plurality of discharge electrodes may include a plurality of discharge electrode pairs, each of the discharge electrode pairs having a first discharge electrode and a second discharge electrode. Each of the first and second discharge electrodes may overlap with one of the first or second barrier rib portions. Each of the first and second discharge electrodes may be directly above the respective one of the first or second barrier rib portions. Each of the first discharge electrodes may correspond to a X discharge electrode, and each of the second discharge electrodes may correspond to a Y discharge electrode, each the X discharge electrodes being above the respective one of the first barrier rib portions. Each of the X discharge electrodes may be adapted to receive a different voltage waveform than the Y discharge electrode. Each of the discharge electrodes may include two X discharge electrodes or two Y discharge electrode. Each of the first or second rib portions may completely overlap the respective one of the first and second discharge electrodes.

At least one of the above and other features and advantages of the present invention may be further realized by providing a method of forming a PDP with first and second substrates, including forming an upper dielectric layer on the first substrate, disposing a plurality of discharge electrodes between the first and second substrates, and forming a plurality of barrier ribs between the first and second substrates, such that each barrier rib has a first width different than a central width thereof, and such that each barrier rib is colored via subtractive mixing to form dark regions.

Forming the barrier ribs may include performing wet etching. Performing wet etching may include applying an etching solution to a barrier rib paste after firing the barrier rib paste. Using a subtractive mixing to form dark regions may include coloring the upper dielectric layer and/or the first substrate with a substantially blue color, and coloring the plurality of barrier ribs with a substantially brown color.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial exploded perspective view of a plasma display panel (PDP) according to an embodiment of the present invention;

FIG. 2 illustrates a cross-sectional view along line II-II of FIG. 1;

FIG. 3 illustrates a cross-sectional view along line III-III of FIG. 1;

FIG. 4 illustrates a plan view of the PDP of FIG. 1;

FIG. 5 illustrates a partial exploded perspective view of a PDP according to another embodiment of the present invention;

FIG. 6 illustrates a cross-sectional view along line VI-VI of FIG. 5;

FIG. 7 illustrates a cross-sectional view along line VII-VII of FIG. 5; and

FIG. 8 illustrates a plan view of the PDP of FIG. 5.

### DETAILED DESCRIPTION OF THE INVENTION

Korean Patent Application No. 10-2007-0030364, filed on Mar. 28, 2007, in the Korean Intellectual Property Office, and entitled: “Plasma Display Panel,” is incorporated by reference herein in its entirety.

Exemplary embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

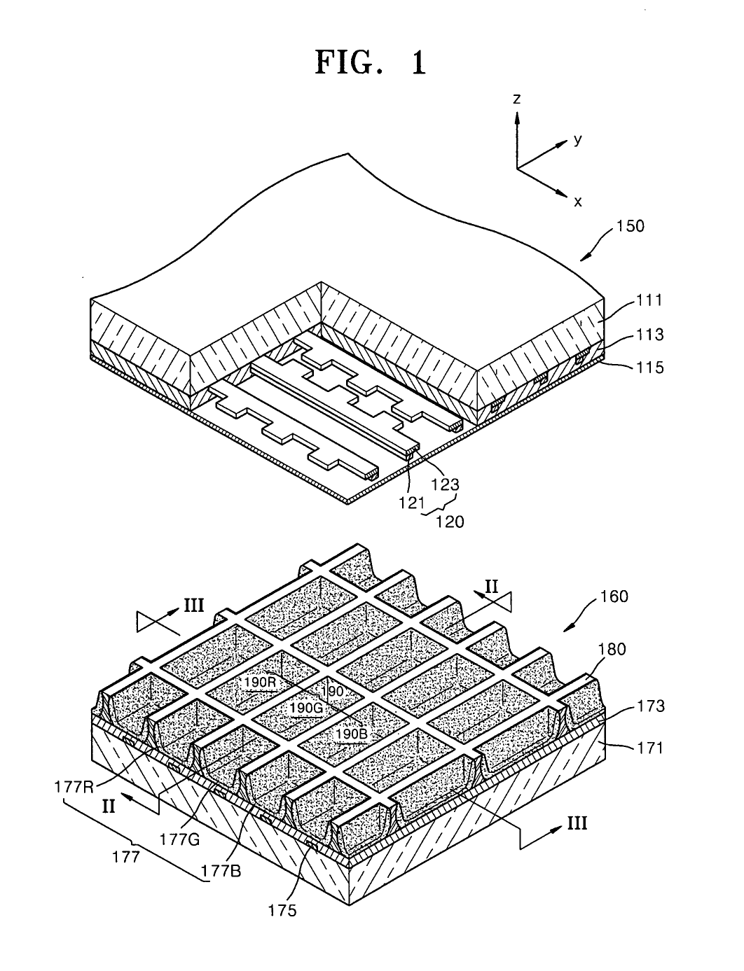

An exemplary embodiment of a plasma display panel (PDP) according to the present invention will now be described more fully with reference to FIGS. 1-4. As illustrated in FIGS. 1-4, a PDP may include an upper panel 150 having a first substrate 111 with a plurality of discharge electrodes 120, an upper dielectric layer 113, and a passivation layer 115. The PDP may further include a lower panel 160 having a second substrate 171 with a plurality of address electrodes 175, a lower dielectric layer 173, barrier ribs 180, and photoluminescent layers 177. The upper and lower panels 150 and 160 may be attached to one another, such that the plurality of discharge and address electrodes 120 and 175 may face one another and facilitate discharge in a discharge space, i.e., a plurality of discharge cells 190 including red, green, and blue discharge cells 190R, 190G, and 190B, between the upper and lower panels 150 and 160.

The first substrate 111 of the upper panel 150 may be formed of a material exhibiting high optical transmittance, e.g., glass. Further, the first substrate 111 may be colored with a predetermined color to reduce external light reflection, thereby increasing bright room contrast. The predetermined color of the first substrate 111 may be a complimentary color with respect to the barrier ribs 180, as will be discussed in detail below.

The plurality of discharge electrodes 120 of the upper panel 150 may be positioned on the first substrate 111 along the x-axis, as illustrated in FIG. 1. Each discharge electrode 120 may include a transparent electrode 123 and a bus electrode 121, so that each transparent electrode 123 may be disposed between the first substrate 111 and a respective bus electrode 121. Accordingly, voltage application to the transparent electrode 123 may generate and maintain discharge in corresponding red, green, and blue discharge cells 190R, 190G, and 190B arrayed along the transparent electrode 123. The bus electrode 121 may compensate for a relatively high resistance of the transparent electrode 123, thereby providing a substantially uniform voltage to the plurality of red, green, and blue discharge cells 190R, 190G, and 190B. Each transparent electrode 123 may be formed of a material exhibiting high transmittance of visible light and low resistance, e.g., indium-tin-oxide (ITO), while each bus electrode 121 may be formed of a metal, e.g., chromium (Cr), copper (Cu), or aluminum (Al).

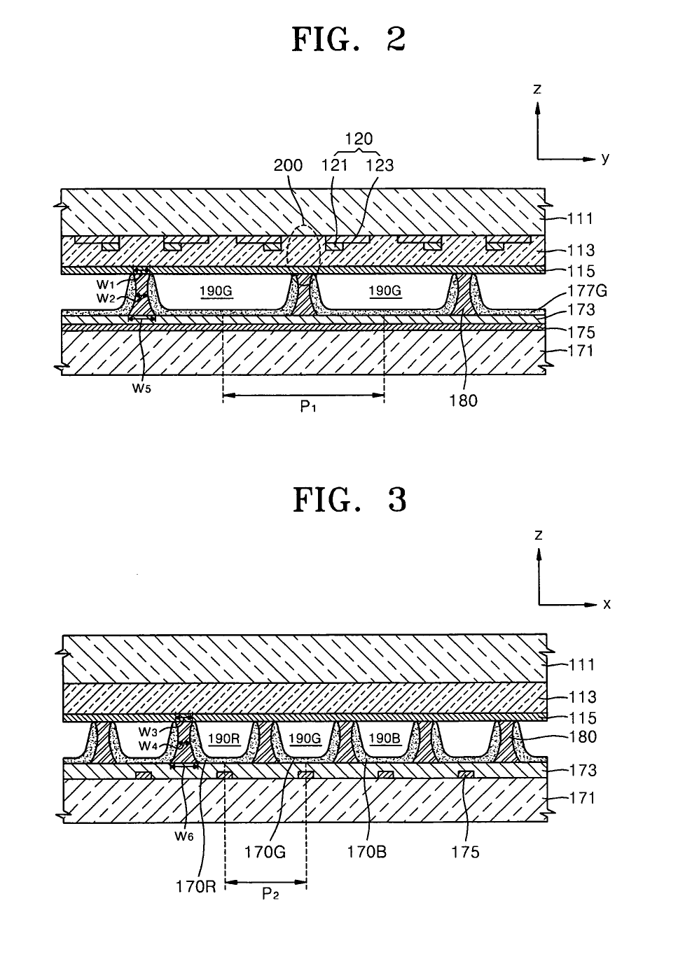

The upper dielectric layer 113 of the upper panel 150 may be coated on the first substrate 111, so that the discharge electrodes 120 may be positioned between the first substrate 111 and the upper dielectric layer 113, as illustrated in FIGS. 1-2. The upper dielectric layer 113 may accumulate wall charges, thereby limiting a discharge current and reducing memory function and voltage in order to maintain glow discharge. The upper dielectric layer 113 may have a high withstanding voltage and a high visible light transmittance to increase discharge efficiency. The upper dielectric layer 113 may be colored with a complimentary color with respect to the barrier ribs 180, as will be discussed in more detail below.

The passivation layer 115 of the upper panel 150 may be formed of magnesium oxide (MgO) on the dielectric layer 113, so that the passivation layer 115 may be between the dielectric layer 113 and the lower panel 160. Accordingly, the passivation layer 115 may shield the upper dielectric layer 113 from collisions of charged particles, thereby reducing damage to the dielectric layer 113. Further, the passivation layer 115 may increase discharge efficiency via secondary electron emission.

The second substrate 171 of the lower panel 160 may be formed of a material exhibiting high optical transmittance, e.g., glass. For example, the second substrate 171 may be formed of the same material as the first substrate 111 of the upper panel 150. Further, the second substrate 171 may be colored to reduce external light reflection, thereby increasing bright room contrast.

The plurality of address electrodes 175 of the lower panel 160 may be positioned on the second substrate 170 along a first direction, i.e., the y-axis, as illustrated in FIGS. 1-2. The address electrodes 175 may be formed of metal having high electrical conductivity, e.g., Cr, Cu, or Al, so that a substantially similar voltage may be applied to the red, green, and blue discharge cells 190R, 190G, and 190B. Each address electrode 175 may be disposed along an array of discharge cells 190 arranged along the y-axis, e.g., along an array of blue discharge cells 190B.

The lower dielectric layer 173 of the lower panel 160 may be coated on the second substrate 171, as illustrated in FIGS. 1-3, so that the address electrodes 175 may be positioned between the second substrate 171 and the lower dielectric layer 173. The lower dielectric layer 173 may shield the address electrodes 175 from collisions of charged particles. Further, the lower dielectric layer 173 may be formed of a material having high dielectric breakdown strength. If the PDP is a top emission type PDP, the lower dielectric layer 173 may be formed of a material having high dielectric breakdown strength and high optical reflectance in order to increase luminous efficiency.

The barrier ribs 180 of the lower panel 160 may be formed between the upper and lower panels 150 and 160, as illustrated in FIGS. 1-3, to define the plurality of discharge cells 190 having the red, green, and blue discharge cells 190R, 190G, and 190B. The barrier ribs 180 may be arranged in any suitable configuration, e.g., a stripe pattern, a matrix-pattern, a delta-pattern, and so forth. If the barrier ribs 180 are configured in a closed type arrangement, e.g., a matrix pattern, the barrier ribs 180 may define the discharge cells 190 to have any suitable cross-sectional shape in the xy-plane, such as a polygonal shape, e.g., triangular, rectangular, pentagonal, and so forth, a circular shape, e.g., an oval, and so forth.

As illustrated in FIGS. 1-3, the barrier ribs 180 may have a varying-width structure, e.g., bottleneck structure. In other words, a central portion of each of the barrier ribs 180 may have a different width, i.e., a distance as measured along the y-axis and/or along the x-axis, as compared to upper and lower portions of each barrier rib 180. For example, as further illustrated in FIG. 2, a first upper width w1 of the barrier ribs 180 may be wider than a first central width w2 thereof along the first direction, i.e., along the y-axis. Similarly, as illustrated in FIG. 3, a second upper width w3 of the barrier ribs 180 may be wider than a second central width w4 thereof along a second direction, i.e., along the x-axis. The first and second upper widths w1 and w3 may be substantially equal or not. Similarly, the first and second central widths w2 and w4 may be substantially equal or not. It should be noted that first and second lower widths w5 and w6, as illustrated in FIGS. 2-3, may be wider than the first and second central width w2 and w4.

As such, the narrower central portion of each barrier rib 180, i.e., a portion corresponding to the first and/or second central widths w2 and w4, may effectively increase an overall size and/or surface area of each of the discharge cells 190 along the x-axis and/or the y-axis. By providing such a varying-width structure to the barrier ribs 180, a coating surface area for each photoluminescent layer 177R, 177G, and 177B applied onto a respective barrier rib 180 may increase, thereby increasing overall luminance of the PDP.

Further, by providing barrier ribs 180 having varying-widths, stability of the barrier ribs 180 may be maintained and/or increased as compared to barrier ribs having uniformly reduced widths along the x and/or y-axis, e.g., conventional barrier ribs having reduced widths with uniform upper, lower, and central portions. In other words, reducing a width of the barrier ribs 180, e.g., only in a central portion thereof to have a wider upper and/or lower width w1, w3, w5, and/or w6, may reduce and/or minimize brittleness of the barrier ribs 180, thereby decreasing a failure rate thereof.

The varying-width, e.g., bottleneck structure, of the barrier ribs 180 may be formed, e.g., by wet etching. More specifically, a barrier rib paste mixture, e.g., a ceramic material, may be prepared and shaped into a predetermined form of a barrier rib structure on the second substrate 171. Next, a firing process may be performed on the barrier rib structure. Subsequently, a predetermined portion, i.e., a central portion, of the barrier rib structure may be etched with an etch solution and an etch mask to form the bottleneck-shaped barrier ribs 180. The wet etching may be an isotropic etching, so that the etching solution may penetrate through the barrier rib structure to form under-cuts, thereby removing portions thereof to form the bottleneck structure of the barrier ribs 180. Accordingly, it is believed that wet etching may facilitate formation of the bottleneck-shaped barrier ribs 180, thereby minimizing breakage of the barrier ribs 180. In other words, formation of the barrier ribs 180 via, e.g., wet etching, to provide varying-width barrier rib structure, as opposed to, e.g., sand blasting of dried and coated barrier rib paste, may reduce the failure rate of the barrier ribs.

The barrier ribs 180 may be colored with a complimentary color, i.e., as determined by a subtractive mixing method, with respect to the color of the upper dielectric layer 113 and/or the color of the first substrate 111. Accordingly, overlapping regions of the barrier ribs 180 with the upper dielectric layer 1 13 and/or the first substrate 111, e.g., a dark region 200 in FIG. 2, may exhibit a substantially dark or opaque color, e.g., black, dark brown, dark blue, and so forth. For example, if the upper dielectric layer 113 and/or the first substrate 111 is substantially blue, the barrier ribs 180 may be colored with a substantially brown color, i.e., a desaturated orange, so that an overlapping region of the barrier ribs 180 with the upper dielectric layer 113 and/or the first substrate 111, i.e., a region corresponding to an area enclosed by the first and second upper widths w1 and w3 of the barrier rib 180, may exhibit a substantially dark color.

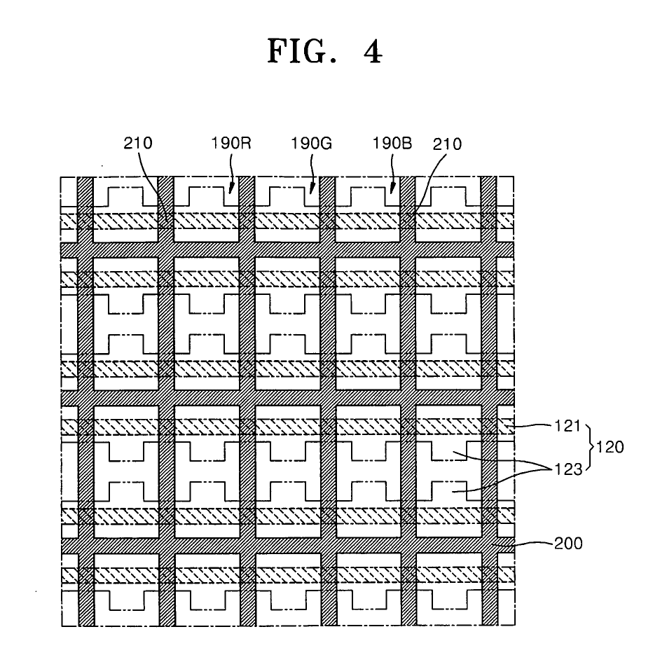

More specifically, as illustrated in FIG. 4, the barrier ribs 180, as viewed through the first substrate 111, may exhibit a substantially dark color to form the dark region 200. In other words, formation of the dark region 200 due to overlapping of the upper dielectric layer 113 and/or the first substrate 111 with the barrier ribs 180 may facilitate absorption of external light, thereby reducing reflection thereof. As further illustrated in FIG. 4, overlap of the bus electrodes 121 of the discharge electrodes 120 with portions of the barrier ribs 180 may form dark portions 210 to further reduce reflection of external light.

The red, green, and blue discharge cells 190R, 190G, and 190B formed by the barrier ribs 180 may be arranged, so that discharge cells having an identical color may be arrayed along the y-axis. For example, a plurality of blue discharge cells 190B may be sequentially positioned along the y-axis. The red, green, and blue discharge cells 190R, 190G, and 190B may be arranged in a repetitive pattern along the x-axis, as illustrated in FIG. 1, to form pixel rows.

As illustrated in FIGS. 2-3, the discharge cells 190 may have a first cell pitch PI, i.e., a distance as measured between centers of adjacent discharge cells 190 along the y-axis, and a second cell pitch P2, i.e., a distance as measured between centers of adjacent discharge cells 190 along the x-axis. For example, the first pitch P1 may be a distance between two centers of green discharge cells 190G along the y-axis. On the other hand, e.g., the second pitch P2 may be a distance between two centers of adjacent red and green discharge cells 190R and 190G along the x-axis.

The first and second cell pitches P1 and P2 of each two adjacent discharge cells 190 may be about 750 μm or less. For example, in a 50-inch full high definition (FHD) PDP having a resolution of 1920×1080, the first cell pitch P1 may be about 611 μm, i.e., a width of a discharge cell along the y-axis of about 576 μm and a first upper width w1 of the barrier rib of about 35 μm. Similarly, the second cell pitch P2 may be about 227 μm, i.e., a width of a discharge cell along the x-axis of about 192 μm and a second upper width w3 of the barrier rib of about 35 μm.

The photoluminescent layers 177R, 177G, and 177B may be coated on surfaces of the barrier ribs 180, as illustrated in FIG. 3, to emit visible light due to excitation by vacuum UV rays. Red photoluminescent layers 177R may include a photoluminescent material emitting red light, e.g., Y(V,P)O₄:Eu. Green photoluminescent layers 177G may include a photoluminescent material emitting green light, e.g., Zn₂SiO₄:Mn or YBO₃:Tb. Blue photoluminescent layers 177B may include a photoluminescent material emitting blue light, e.g., BAM:Eu. As described previously, the coating area of the photoluminescent layers 177R, 177G, and 177B may be enhanced due to the varying-width, e.g., bottleneck structure, of the barrier ribs 180, thereby increasing the amount of emitted visible light and its brightness. The vacuum UV light activating visible light emission may be triggered by generating a discharge in a discharge gas, e.g., neon (Ne), xenon (Xe), helium (He), or a mixture thereof, filled into each discharge cell 190.

The PDP according to an embodiment of the present invention may be operated via a progressive scan method, as opposed to an interlace scan method. For example, if the interlace scan method is used to operate the 50-inch FHD PDP discussed previously, odd numbered rows of vertical scan lines may be scanned first, followed by scanning of even numbered rows of the vertical scan lines. Thus, when using the interlace scan method, e.g., 768 vertical scan lines may be sufficient to display an image. The progressive scan method, on the other hand, may require progressive application of image signals to each of the vertical scan lines, e.g., each of the 1080 vertical scan lines, and may thereby display images with enhanced clarity and precision as compared to the interlace scan method. By using a varying-width barrier ribs 180, an increased number of vertical scan lines may be provided with a reduced pitch therebetween, so that the PDP may exhibit increased brightness and reduced failure rate of barrier ribs as compared to conventional PDPs.

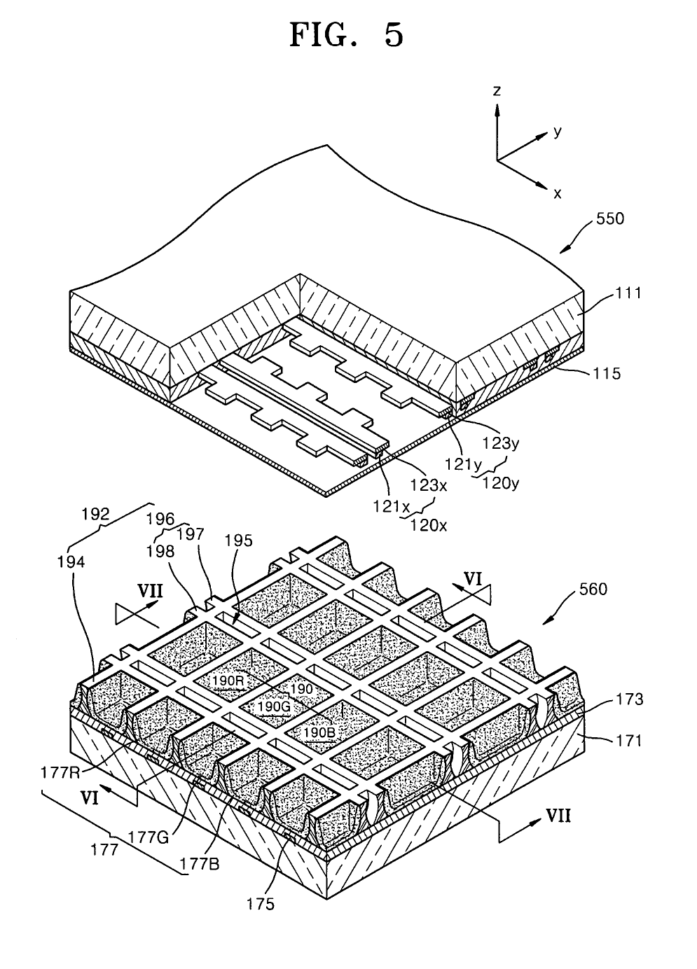

According to another exemplary embodiment illustrated in FIGS. 5-8, a PDP may be similar to the PDP described previously with respect to FIGS. 1-4, with an exception of having a double barrier rib structure. More specifically, as illustrated in FIGS. 5-8, a PDP may include an upper panel 550 having the first substrate 111 with a plurality of pairs of discharge electrodes 120x and 120y, the upper dielectric layer 113, and the passivation layer 115. The PDP may further include a lower panel 560 having the second substrate 171 with the plurality of the address electrodes 175, the lower dielectric layer 173, and barrier ribs 192 with the photoluminescent layers 177.

Referring to FIGS. 5-7, the barrier ribs 192 may include vertical barrier ribs 194 and horizontal barrier ribs 196 that cross the vertical barrier ribs 194. More specifically, the vertical barrier ribs 194 may be positioned along the y-axis, while the horizontal barrier ribs 196 may be positioned along the x-axis, as illustrated in FIGS. 5-7. Each horizontal barrier rib 196 may include a double structure, i.e., a first horizontal barrier rib portion 197 and a second horizontal barrier rib portion 198, so that positioning of a plurality of horizontal barrier ribs 196 may form an arrangement of alternating first and second horizontal barrier rib portions 197 and 198. The first and second horizontal barrier rib portions 197 and 198 of a single horizontal barrier rib 196 may be positioned between adjacent pixel rows along the x-axis, i.e., two pixel rows may be separated by a single horizontal barrier rib 196. Each horizontal barrier rib 196 may include the first horizontal barrier rib portion 197 at a predetermined distance from the second horizontal barrier rib portion 198, so that a non-discharge space 195 may be formed between the first and second horizontal barrier rib portions 197 and 198 of each horizontal barrier rib 196, as further illustrated in FIG. 5. The non-discharge space 195 may be used for effective discharge of exhaust gas.

The plurality of red, green, and blue discharge cells 190R, 190G, and 190B may be defined by the vertical and horizontal barrier ribs 194 and 196. More specifically, as illustrated in FIG. 5, each horizontal array of red, green, and blue discharge cells 190R, 190G, and 190B may be between the first horizontal barrier rib portion 197 of one horizontal barrier rib 196 and the second horizontal barrier rib portion 198 of another horizontal barrier rib 196. In other words, the first and second horizontal barrier rib portions 197 and 198 of the same horizontal barrier rib 196 may have the non-discharge space 195 therebetween. The first and second horizontal barrier rib portions 197 and 198 of adjacent horizontal barrier ribs 196, i.e., a first horizontal barrier rib portion 197 of one horizontal barrier rib 196 and a second horizontal barrier rib portion 198 of an adjacent horizontal barrier rib 196, may have a red, green, or blue discharge cell 190R, 190G, or 190B therebetween, as illustrated in FIG. 5.

The pairs of discharge electrodes 120x and 120y may be substantially similar to the discharge electrodes 120 described previously with respect to FIGS. 1-4, with the exception of having X discharge electrodes and Y discharge electrodes. More specifically, discharge electrodes 120x and 120y may include X discharge electrodes 120x having X transparent electrodes 123x and X bus electrodes 121x, and Y discharge electrodes 120Y having Y transparent electrodes 123y and Y bus electrodes 121y. Each horizontal barrier rib 196 may have, e.g., two X bus electrodes 121x, two Y bus electrodes 121y, or a pair of X and Y bus electrodes 121x and 121y thereabove. Formation of the X and Y bus electrodes 121x and 121y along the horizontal barrier ribs 196 may increase the opening ratio of the PDP, thereby enhancing discharge efficiency. Alternatively, as illustrated in FIG. 5, a pair of a X bus electrode 121x and a Y bus electrode 121 y may be formed above corresponding first and second horizontal barrier rib portions 197 and 198 of one of the horizontal barrier ribs 196. In such cases, different voltage waveforms may be applied to the first and second horizontal barrier rib portions 197 and 198 of one of the horizontal barrier ribs 196.

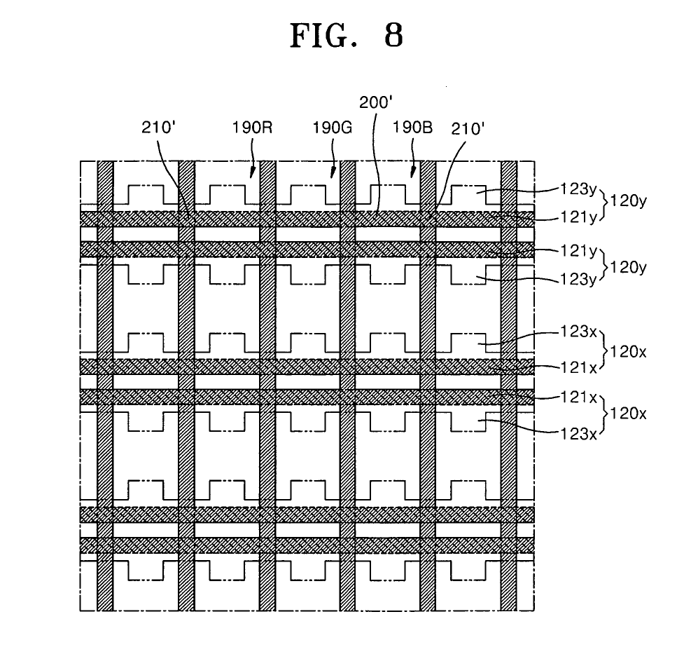

For example, two X bus electrodes 121x may be formed above, e.g., partial overlap, complete overlap, etc., corresponding first and second horizontal barrier rib portions 197 and 198 of one of the horizontal barrier ribs 196, as illustrated in FIG. 8. Similarly, two Y bus electrodes 121y may be formed above corresponding first and second horizontal barrier rib portions 197 and 198 of another of the horizontal barrier ribs 196, as further illustrated in FIG. 8. Accordingly, the X and Y discharge electrodes 120x and 120y may be disposed in parallel to the x-axis in a double-alternating pattern, i.e., two X discharge electrodes 120x, two Y discharge electrodes 120y, and so forth. Therefore, a substantially same voltage waveform may be applied to the respective discharge electrodes 120x and/or 120y above the first and second horizontal barrier rib portions 197 and 198 of a single horizontal barrier rib 196.

Formation of such an XX-YY discharge electrode arrangement with respect to the horizontal barrier ribs 196 may reduce power consumption in the PDP, reduce cross-talk among adjacent discharge cells 190, enable a width of the X and/or Y bus electrodes 121x, 121y be increased, and/or a width of the X and/or Y transparent electrodes 123x, 123y be decreased.

The barrier ribs 192 may be colored with a complementary color with respect to the upper dielectric layer 113 and/or the first substrate 111, as determined by the subtractive mixture method and as described previously with reference to the PDP illustrated in FIGS. 1-4. As illustrated in FIG. 8, the barrier ribs 192, as viewed through the first substrate 111, may exhibit a substantially dark color to form the dark region 200′. Further, overlap of the X and Y bus electrodes 121x and 12 1y of the X and Y discharge electrodes 120x and 120y with portions of the vertical barrier ribs 194 may form dark portions 210′, thereby reducing reflection of external light.

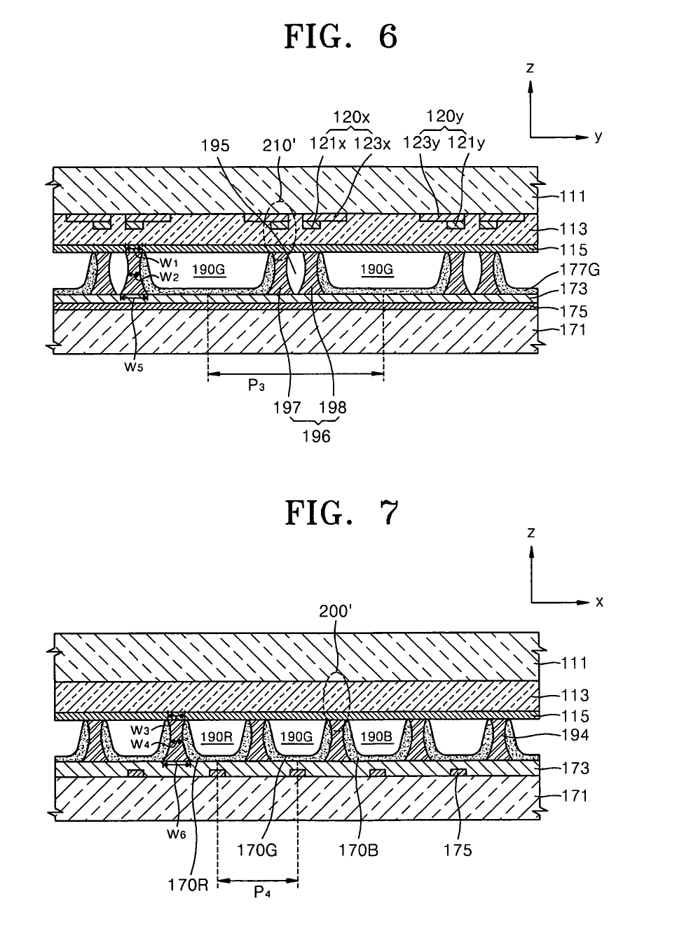

The barrier ribs 192 may have a varying-width, e.g., bottleneck, shape formed, e.g., via a wet etching method, as described previously with respect to the barrier ribs of the PDP illustrated in FIGS. 1-4, thereby imparting substantially similar advantages as described previously with respect to the PDP of FIGS. 1-4. In this respect, as illustrated in FIGS. 6-7, it should be noted that each of the vertical barrier ribs 194, the first horizontal barrier rib portions 197, and the second horizontal barrier rib portions 198 may have the first and second upper widths w1 and w3, the first and second central widths w2 and w4, and the first and second lower widths w5 and w6, as described previously with respect to FIGS. 1-4.

The discharge cells 190R, 190G, and 190B between the barrier ribs 192 may have a third cell pitch P3, i.e., a distance as measured between centers of adjacent discharge cells 190R, 190G, and 190B along the y-axis, and a fourth cell pitch P4, i.e., a distance as measured between centers of adjacent discharge cells 190R, 190G, and 190B along the x-axis. The third cell pitch P3 may include a length of a discharge region, a total upper width of the first and second horizontal barrier rib portions 197 and 198, and a width of an exhaust gas path, i.e., a distance between the first and second horizontal barrier rib portions 197 and 198. The fourth cell pitch P4 may include a length of a discharge region and an upper width of the vertical barrier rib 194. For example, in a 50-inch FHD PDP, appropriate brightness and reduced barrier rib failure may be provided by setting the third cell pitch P3 to be about 716 μm, i.e., a length of a discharge cell of about 576 μm, an upper width of a barrier rib of about 35 μm, and a width of an exhaust gas path of about 105 μm. The fourth cell pitch P4 may be about 227 μm, i.e., a length of a discharge cell of about 192 μm and an upper width of a vertical barrier rib 194 of about 35 μm. Accordingly, the third and fourth cell pitches P3 and P4 of each two adjacent discharge cells 190R, 190G, and 190B may be about 750 μm or less.

As described above, a PDP according to embodiments of the present invention may include barrier ribs having a varying-width structure, e.g., bottleneck structure, and/or a complimentary color with respect to the upper dielectric layer and/or the first substrate of the PDP to increase a size of each discharge cell, thereby enhancing brightness of the emitted visual light and reducing external light reflection. Further, the varying-width structure, e.g., bottleneck structure, of the barrier ribs may reduce breakage thereof, despite reduced cell pitch of the barrier ribs.

Exemplary embodiments of the present invention have been disclosed herein, and although specific terms are employed, they are used and are to be interpreted in a generic and descriptive sense only and not for purpose of limitation. For example, upper and lower portions of the barrier ribs are descriptive terms that are not limited to specific orientations, and may be interpreted as first and second portions, respectively. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a first substrate and a second substrate facing each other;
an upper dielectric layer on the first substrate;
a plurality of discharge electrodes between the first and second substrates; and
a plurality of barrier ribs to define a plurality of discharge cells between the first and second substrates, each of the barrier ribs having a first portion and a central portion, the first portion having a width different than a width of the central portion, and each of the barrier ribs having a complimentary color with respect to a color of the first substrate and/or a color of the upper dielectric layer.

2. The PDP as claimed in claim 1, wherein the central portion of each barrier rib is between the first portion and a second portion, the first portion being wider than the central portion.

3. The PDP as claimed in claim 2, wherein the second portion of each barrier is wider than the central portion.

4. The PDP as claimed in claim 1, wherein the upper dielectric layer and/or the first substrate overlaps with portions of the barrier ribs to define opaque regions.

5. The PDP as claimed in claim 4, wherein the upper dielectric layer and/or the first substrate is substantially blue and the barrier ribs are substantially brown.

6. The PDP as claimed in claim 1, wherein a cell pitch of the discharge cells is about 750 μm or less.

7. The PDP as claimed in claim 1, further comprising a photoluminescent layer in each discharge cell.

8. The PDP as claimed in claim 1, wherein at least a first set of the barrier ribs extend parallel to the discharge electrodes and include a double structure.

9. The PDP as claimed in claim 8, wherein each of the barrier ribs of the first set includes a first barrier rib portion and a second barrier rib portion with a non-discharge space therebetween.

10. The PDP as claimed in claim 9, wherein the plurality of discharge electrodes include a plurality of discharge electrode pairs, each of the discharge electrode pairs having a first discharge electrode and a second discharge electrode.

11. The PDP as claimed in claim 10, wherein each of the first and second discharge electrodes overlaps with one of the first or second barrier rib portions.

12. The PDP as claimed in claim 11, wherein each of the first and second discharge electrodes is directly above the respective one of the first or second barrier rib portions.

13. The PDP as claimed in claim 11, wherein each of the first discharge electrodes corresponds to a X discharge electrode and each of the second discharge electrodes corresponds to a Y discharge electrode, each of the X discharge electrodes being above the respective one of the first barrier rib portions.

14. The PDP as claimed in claim 13, wherein each of the X discharge electrodes is adapted to receive a different voltage waveform than the Y discharge electrode.

15. The PDP as claimed in claim 11, wherein each of the discharge electrodes includes two X discharge electrodes or two Y discharge electrode.

16. The PDP as claimed in claim 11, wherein each of the first or second rib portions completely overlaps the respective one of the first and second discharge electrodes.

17. A method of forming a plasma display panel (PDP) including first and second substrates, comprising:
forming an upper dielectric layer on the first substrate;
disposing a plurality of discharge electrodes between the first and second substrate; and
forming a plurality of barrier ribs between the first and second substrates, such that each barrier rib has a first width different than a central width thereof, and such that each barrier rib is colored via subtractive mixing to form dark regions.

18. The method as claimed in claim 17, wherein forming the barrier ribs includes performing wet etching.

19. The method as claimed in claim 18, wherein performing wet etching includes applying an etching solution to a barrier rib paste after firing the barrier rib paste.

20. The method as claimed in claim 17, wherein using a subtractive mixing to form dark regions includes coloring the upper dielectric layer and/or the first substrate with a substantially blue color, and coloring the plurality of barrier ribs with a substantially brown color.
